(19) United States
(12) Patent Application Publication
(10) Pub. No.: US 2007/0075873 A1
(43) Pub. Date: Apr. 5, 2007

(54) LOCATION AWARENESS SYSTEM USING RFID AND WIRELESS CONNECTIVITY APPARATUS FOR LOCATION AWARENESS SYSTEM USED THEREIN

(75) Inventors: Chang Soo Yang, KYUNGKI-DO (KR); Jeong Suk Lee, KYUNGKI-DO (KR); Sang Do Cho, KYUNGKI-DO (KR); Kwang Du Lee, JEONLANAM-DO (KR); Wan Chul Yang, KYUNGKI-DO (KR); Kyu Hwan An, SEOUL (KR); Jong In Na, SEOUL (KR); Ki Hwan Kim, KYUNGKI-DO (KR); Sang Gyu Park, BUSAN (KR); Sang Yub Lee, KYUNGKI-DO (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., KYUNGKI-DO (KR)

(21) Appl. No.: 11/537,201

(22) Filed: Sep. 29, 2006

(30) Foreign Application Priority Data
Sep. 30, 2005 (KR) 10-2005-92282

(51) Int. Cl. G08B 5/22

(52) U.S. Cl. 340/825.49

(57) ABSTRACT

A location awareness system using RFID and a wireless communication apparatus for the location awareness are provided. The location awareness system includes a RFID tag, a wireless communication apparatus for location awareness, more than three anchors, a coordinator, and a server. The wireless communication apparatus identifies the target object with the RFID attached through communicating with the RFID tag. The anchors receive information about the identified target object and measuring a distance by communication with the wireless communication apparatus using a predetermined wireless communication scheme. The coordinator collects the measure distance and the information from each of the anchors. The server calculates a location of the target object by receiving information about the measured distances and the target objects from the coordinator and calculating the location of the wireless communication apparatus using the received information.

### RELATED APPLICATION

The present application is based on, and claims priority from, Korean Application Number 2005-92282, filed Sep. 30, 2005, the disclosure of which is hereby incorporated by reference herein in its entirety.

### BACKGROUND OF THE INVENTION

1. Field of the Invention

The present invention relates to a location awareness system using radio frequency identification (RFID) and a wireless communication apparatus for the location awareness therein, and more particularly, to a location awareness system using RFID for effectively sensing a plurality of target objects using a passive RFID technology for a short distance range, and a wireless communication apparatus for location awareness used therein.

2. Description of the Related Art

Generally, a wireless communication technology is classified into a long range wireless communication technology and a short range wireless communication technology according to a service range. That is, the long range wireless communication technology provides a wireless communication service in very wide area, and the short range wireless communication technology provides a wireless communication service in a short range such as a home, an office, a factory, and a warehouse.

The conventional short range wireless communication technology allows a voice communication through a walkie-talkie and allows simple and small data transmission. As the digital communication technology and semiconductor technology have been rapidly developed, various short range wireless communication solutions have been introduced for transmitting various data through a wireless link, controlling equipment through a wireless link, and transmitting multimedia such as voice, audio and vide. Especially, wireless communication solutions for sensing the locations of objects in a short communication network have been introduced.

FIG. 1 is a diagram illustrating a conventional location awareness system. As shown in FIG. 1, the conventional location awareness system includes a wireless communication apparatus 140 for location awareness which is disposed at a target object of location awareness in a short range communication network (P), a plurality of anchors 131 to 133 for measuring distances to the wireless communication apparatus 140 using a predetermined wireless communication technology such as, wireless LAN, Bluetooth or Zigbee, a coordinator 120 for collecting the measured distances from the anchors 131 to 133, and a server 110 for receiving the collected distance information from the coordinator 120, calculate the location of the wireless communication apparatus 140 and displaying it.

However, the conventional location awareness system has a disadvantage that the fixed anchors 131 to 133 and the wireless communication apparatus 140 disposed at the target object are expensive. That is, there is no problem to dispose the wireless communication apparatus 140 at a target object that is always present in the short range communication network P. However, it is almost impossible to dispose the wireless communication apparatuses to objects, which are temporary present in a communication network, in a view of time and cost. For example, it is almost impossible to dispose the wireless communication apparatuses to all of goods that are stacked at a warehouse for shipping. Although the wireless communication apparatuses 140 are disposed at all of the goods, it is very difficult to collect them from the goods after the gods are shipped. Furthermore, it is impossible to dispose the wireless communication apparatuses 140 to objects when the objects are very small and very densely arranged. Moreover, the large quantity of electric power is required to operate the wireless communication apparatuses 140.

In order to overcome the disadvantages of the conventional location awareness system shown in FIG. 1, a location awareness system using RFID was introduced. FIG. 2 is a diagram showing a conventional location awareness system using RFID.

As shown in FIG. 2, in the location awareness system using a RFID, a cheap RFID tag 160 is attached at a target object 150 for location awareness, which is present in a corresponding communication network P, and a RFID reader 170 for reading the RFID tag 160 is disposed. Since the RFID tag 160 is very cheap, it is not required to be recollected. The location of the target object 160 can be sensed by sensing the location of the RFID tag 160 using the RFID reader 170.

However, a passive RFID allows the RFID reader 170 to read itself in a short range, for example, about 1 m, and requires the RFID reader 170 to be fixed at a predetermined location. That is, the RFID reader 170 must be located within ranges A and B, for example, about 1 m, from the target objects 150 and 160. It is impossible to detect the location of the RFID reader 170 when the RFID reader 170 moves as shown in FIG. 2. Therefore, the RFID reader 170 must be fixed at a predetermined location. That is, a plurality of RFID readers 170 are required to be disposed in a network. For example, about 900 RFID readers are required for a network P with about 30 m radius. Therefore, the conventional location awareness requires a high cost due to the large number of RFID readers.

### SUMMARY OF THE INVENTION

Accordingly, the present invention is directed to a location awareness system using RFID and a wireless communication apparatus for location awareness used therein that substantially obviates one or more problems due to limitations and disadvantages of the related art.

An object of the present invention is to provide a location awareness system using RFID for effectively detecting the locations of a plurality of target objects using a RFID technology, and a wireless communication apparatus for location awareness used therein.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a location awareness system using RFID (radio frequency identification) includes: a RFID tag disposed at a target object for location awareness; a wireless communication apparatus for location awareness for identifying the target object through communicating with the adjacent RFID tag; more than three fixed anchors for receiving information about the identified target object and measuring a distance to the wireless communication apparatus by communication with the wireless communication apparatus using a predetermined wireless communication scheme; a coordinator for collecting the measure distance and the information about the target objects from each of the anchors; and a server for calculating a location of the target object by receiving information about the measured distances and the target objects from the coordinator and calculating the location of the wireless communication apparatus using the received information.

The wireless communication apparatus may be disposed at a target object in which the RFID tag is not disposed. That is, the wireless communication apparatus is not only used for detecting the location of target object with the RFID tag through communicating with the RFID tag but also directly disposed at the target object.

The wireless communication apparatus may include: a RFID reader for identifying the target object through communicating with the RFID tag; a memory for storing information about the identified target object from the RFID reader; a wireless transceiving unit for transmitting the information about the target object stored in the memory to the anchors and transmitting a response signal for the received distance signal to the anchor using a predetermined wireless communication scheme; and a micro controller for controlling operations of the RFID reader, the wireless transceiving unit and the memory.

For example, the predetermined wireless communication scheme may be a wireless communication scheme applicable to a wireless personal area network (W-PAN) such as wireless LAN, Bluetooth, and Zigbee.

The wireless communication apparatus may further include a terminal interface for connecting to other type of a reader instead of the RFID type reader.

For example, the other type reader may be a bar code reader.

According to an aspect of the present invention, there is provided a wireless communication apparatus for location awareness, which communicates with a RFID tag attached at a target object and communicates with anchors to calculate a distance in a location awareness system, the wireless communication apparatus including: a RFID reader for identifying the target object through communicating with the RFID tag; a memory for storing information about the target object identified at the RFID reader; a wireless transceiving unit for transmitting the information about the target object stored in the memory to the anchors and transmitting a response signal for a distance calculating signal to anchors using a predetermined wireless communication scheme; and a micro controller for controlling operations of the RFID reader, the wireless transceiving unit and the memory.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a conventional location awareness system;

FIG. 2 is a diagram showing a conventional location awareness system using RFID according to the related art;

FIG. 3 is a view illustrating a location awareness system using RFID according to an embodiment of the present invention; and

FIG. 4 is a block diagram illustrating a wireless communication apparatus according to an embodiment of the present invention.

### DETAILED DESCRIPTION OF THE INVENTION

Reference will now be made in detail to the preferred embodiments of the present invention, examples of which are illustrated in the accompanying drawings.

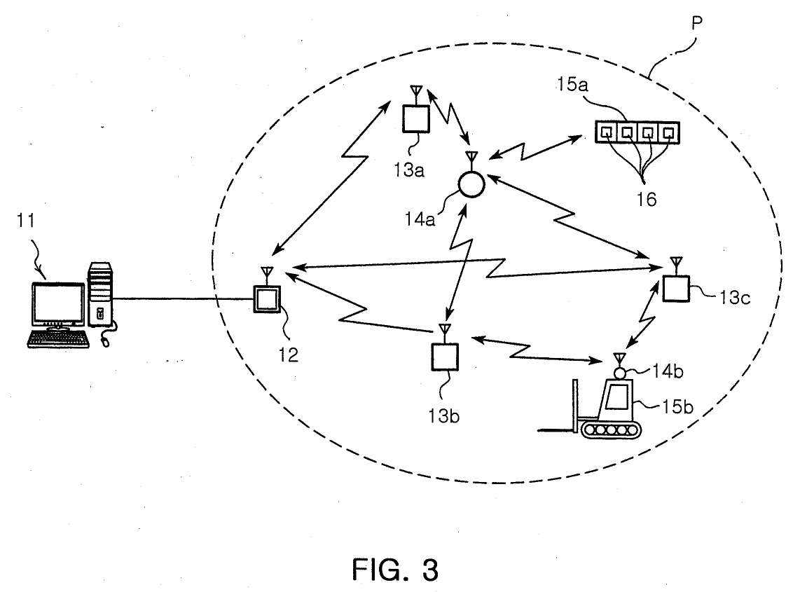

FIG. 3 is a view illustrating a location awareness system using RFID according to an embodiment of the present invention.

As shown in FIG. 3, the location awareness system according to the present embodiment includes a RFID tag 16 disposed at a target object 15a, a wireless communication apparatus 14a for identifying the target object for location awareness through communicating with the adjacent RFID tag 16, more than three anchors 13a to 13c for receiving information about the identified target object 15a and measuring distances to the wireless communication apparatus 14a through communicating with the wireless communication apparatus 14a using a predetermined wireless communication scheme, a coordinator 12 for collecting information about the measured distances and the target objects from the anchors 13a to 13c, and a server 11 for receiving the information about the measured distances and the target objects from the coordinator 12 and calculating the location of the target object 15a through calculating the location of the wireless communication apparatus 14b based on the received information.

The RFID tag 16 is disposed at a target object 15a for the location awareness. The RFID tag 16 may include information about a corresponding target object 15a.

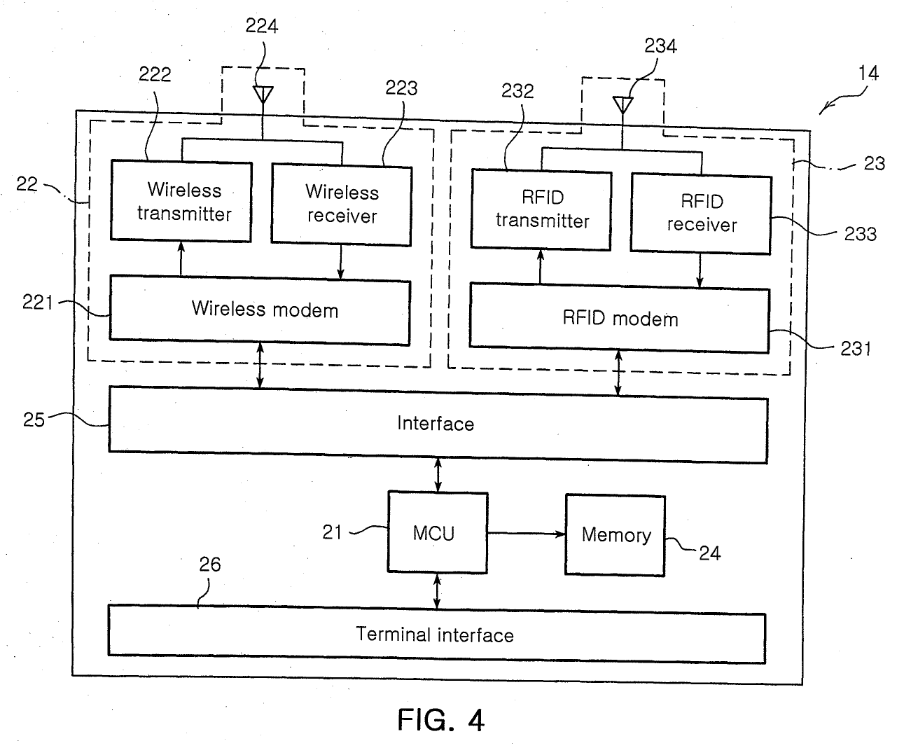

The wireless communication apparatus 14a identifies a target object through communicating with the RFID tag 16. Also, the wireless communication apparatus 14a enables the anchors 13a to 13c to calculate a distance to the wireless communication apparatus 14a through communicating with the anchors 13a to 13c. In order to identify the target object and to enable the anchors to calculate the distance, the wireless communication apparatus 14a may have a structure shown in FIG. 4.

FIG. 4 is a block diagram illustrating a wireless communication apparatus according to an embodiment of the present invention.

Referring to FIG. 4, the wireless communication apparatus 14 according to the present embodiment includes a RFID reader 23 for identifying a target object 15a in FIG. 3 through communicating with the RFID tag 16 in FIG. 3, a memory 24 for storing information about the target object identified by the RFID reader 23, a wireless transceiving unit 22 for transmitting the target object information stored in the memory 24 to the anchors 13a to 13c in FIG. 3 and transmitting a response signal to the anchors 13a to 13c for the received distance signal from the anchors 13a to 13c using a predetermined wireless communication scheme, and a micros controller 21 for controlling the operations of the RFID reader 23, the wireless transceiving unit 22 and the memory 24.

The RFID reader 23 may include a RFID transmitter 232 for providing power and signals for reading the RFID tag 16 of FIG. 3, a RFID receiver 233 for receiving information from the RFID tag 16 of FIG. 3, and a RFID MODEM 231 for modulating and demodulating information used for transceiving data with the RFID tag 16 of FIG. 3.

The wireless transceiving unit 22 includes a wireless receiver 223 for receiving a signal from the anchors 13a to 13c of FIG. 3, a wireless transmitter 222 for transmitting a signal to the anchors 13a to 13c of FIG. 3, and a MODEM 221 for modulating and demodulating information used to transmit and receive data to/from the anchors 13a to 13c of FIG. 3. The wireless transceiving unit 22 may be used to measure a distance between the wireless communication apparatus 14 and the anchors 13a to 13c. To measure the distance, all of communication schemes applicable to a wireless personal private network (W-PAN) can be used. For example, a wireless LAN, a Bluetooth and Zigbee can be used.

The memory 24 stores the information of RFID tag read by the RFID reader 23.

The RFID reader 23, the wireless transceiving unit 22 and the memory 24 may be controlled by the micro controller 21.

The RFID reader 23 and the wireless transceiving unit 22 may communicate with the micro controller 21 through an interface 25, and the memory 24 may have a structure to directly communicate with the micro controller 21.

The wireless communication apparatus 14 according to the present invention may further include a terminal interface 26 for other types of reading devices instead of the RFID reader. For example, a barcode reader may be used as the other type of the reading device. In case of the barcode reader connected to the wireless communication apparatus 14, the wireless communication apparatus 14 identifies a target object with a predetermined barcode printed and stores the read information at a memory. Then, the wireless communication apparatus 14 senses the location of the target object with the barcode printed by communicating with the anchors with the stored read information.

Referring to FIG. 3 again, the anchors 13a to 13c collects information about the identified target object 15a and measures distances to the wireless communication apparatus 14a through communicating with the wireless communication apparatus 14a using a predetermined wireless communication scheme.

The anchors 13a to 13c and the wireless communication apparatus 14a may exchange two types of information. At first, the wireless communication apparatus 14a may transmit the information of identified target object 15a to the anchors 13a to 13c by communicating with the RFID tag 16. Secondly, the signal for measuring a distance between the anchors 13a to 13c and the wireless communication apparatus 14a may be exchanged between the anchors 13a to 13c and the wireless communication apparatus 14a. In more detail, the anchors 13a to 13c transmit a distance measuring signal to the wireless communication apparatus 14a using a predetermined wireless communication scheme. The wireless communication apparatus 14a transmits a response signal for the distance measuring signal to corresponding anchors 13a to 13c. The anchors 13a to 13c calculate the distance to the wireless communication apparatus 14a using the response signal and the distance measuring signal.

Herein, as the wireless communication scheme between the anchors 13a to 13c and the wireless communication apparatus 14a, wireless LAN, Bluetooth and Zigbee may be used.

The communication scheme for measuring a distance between the anchors 13a to 13c and the wireless communication apparatus 14a was introduced in Korea Patent Applications No. 10-2005-00441551 and No. 10-2005-0072184 filed by the same applicant of the present invention. Since the major aspect of the present invention is not mainly related to the communication scheme for measuring the distance, detailed description thereof is omitted herein.

The coordinator 12 collects the information about the measured distances and the target objects from each of the anchors 13a to 13c.

The server 11 receives the information about the measured distances and the target object from the coordinator 123, and calculates the location of the wireless communication apparatus 14a using the received information so as to calculate the location of the target object 15a. That is, the server 11 receives the distance information between the wireless communication apparatus 14a and each of the anchors 13a to 13c, and calculate the location of the wireless communication apparatus 14a using the received distance information. Herein, the wireless communication apparatus 14a is located very close to the target object 15a because the wireless communication apparatus 14a communicates with the RFID tag 16 disposed at the target object 15a in a short range, for example, about 1 m. Therefore, the server 11 can detect the location of the target object 15a having a corresponding RFID tag 16 through detecting the location of wireless communication apparatus 14a that reads the RFID tag 16.

In the present embodiment, the locations calculated by the anchors 11 are two-dimensional location information calculated using three distance information obtained from the three anchors 13a to 13c which are fixed at predetermined locations. For example, more than four anchors which are disposed at different heights may be used for obtaining three-dimensional location information of target object to sense.

Hereinafter, the operations of the location awareness system according to the present invention will be described with reference to FIGS. 3 and 4.

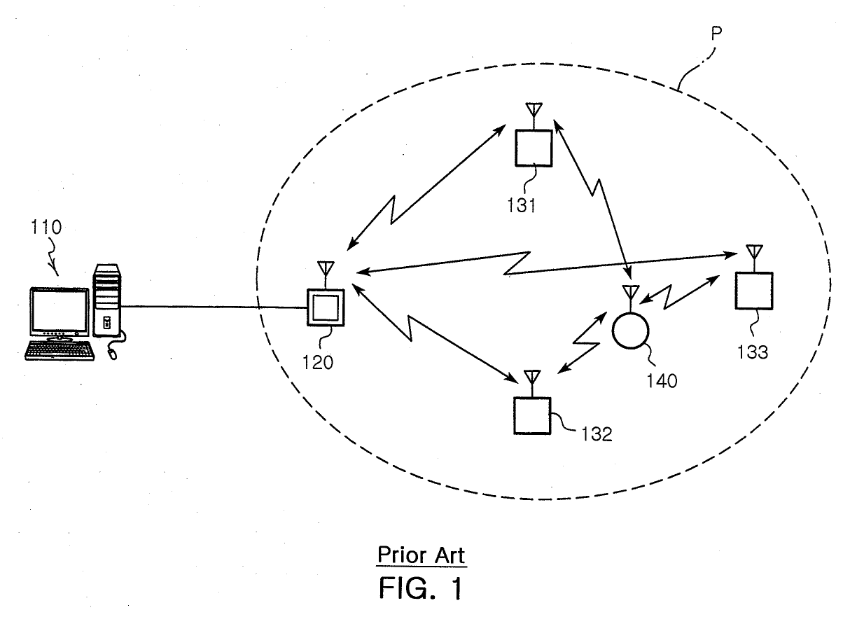

In the present invention, whether to employ the RFID type reader or not is decided according to the type of target object. For example, if the target object is an object 15a that is frequently shipped and densely stacked as like goods in a warehouse, a RFID tag 16 is disposed at the target object 15a and a portable wireless communication apparatus 14a can be used to detect the location of the target object 15a. Meanwhile, if the target object is a huge object 15b that is always present in the network or not densely stacked, for example, a forklift, the RFID tag 16 is not used. In stead of using the RFID tag 16, the wireless communication apparatus 14b may be directly disposed at the target object 15b. In this case, the wireless communication apparatus 14b does not use the RFID reader 23 for communicating with the RFID tag. Since the operations of the location awareness in case of the wireless communication apparatus 14b directly disposed at the target object 15b are identical to those described with reference to FIG. 1, the detailed description thereof is omitted.

When the wireless communication apparatus 14a enters into a range of a passive RFID by traveling around the target object with a RFID tag 16a disposed, the RFID reader 23 of the wireless communication apparatus 14a communicates with the RFID tag attached at the target object 15a. Herein, the RFID transmitter 232 of the RFID reader 22 provides power and signals to read the RFID tag 16a, and the RFID tag 16a transmits the information about the corresponding target object 15a. As a result, the RFID receiver 233 receives the information. In this operation, the MODEM in the RFID reader 23 modulates and demodulates information used for transceiving data with the RFID tag 16 of FIG. 3.

The information of the target object 15a received from the RFID reader 23 may be stored in the memory of the wireless communication apparatus 14a.

Meanwhile, each of the anchors 13a to 13c transmits a distance measuring signal to the wireless communication apparatus 14a, and the wireless communication apparatus 14a transmit the response signal for receiving the distance measuring signal to the corresponding anchors 13a to 13c. Herein, the wireless communication apparatus 14a may transmit information about target objects stored in the memory 24 to the anchors 13a to 13c. The receiver 223 of the wireless transceiving unit 22 in the wireless communication apparatus 14a may receive the distance measuring signal transmitted from the anchors 13a to 13c, and the transmitter 222 of the wireless transceiving unit 22 in the wireless communication apparatus 14a may transmit the response signal for the distance measuring signal. The MODEM 221 modulates and demodulates the information used to transmit and receive information with the anchors 13a to 13c.

The micro processor 21 may control transmission, modulation, and demodulation of the RFID reader 23 and the wireless transceiving unit 22 in the wireless communication unit 14a, and the storing operation of the memory 24. Data migration between the micro processor 21, the RFID reader 23 and wireless transceiving unit 22 may be achieved through an interface 25.

Each of the anchors 13a to 13c calculates a distance to the wireless communication apparatus 14a using a time of transmitting the distance measuring signal and another time of receiving the response for therefore.

The coordinator 12 collects the calculated distance information and the information of the target object from the anchors 13a to 13c, and transfers the collected information to the server 11. The server 11 calculates the location of the wireless communication apparatus 14a that communicates with the RFID tag 16 using the transferred distance information. In order to communicate with a RFID tag 16 disposed at the target object 15a, the wireless communication apparatus 14a with the RFID reader 23 must be located at a very short range, for example, about 1 m, from the RFID tag 16. Therefore, the server 11 can detect the location of the target object with the RFID tag 16 by calculating the location of the wireless communication apparatus 14.

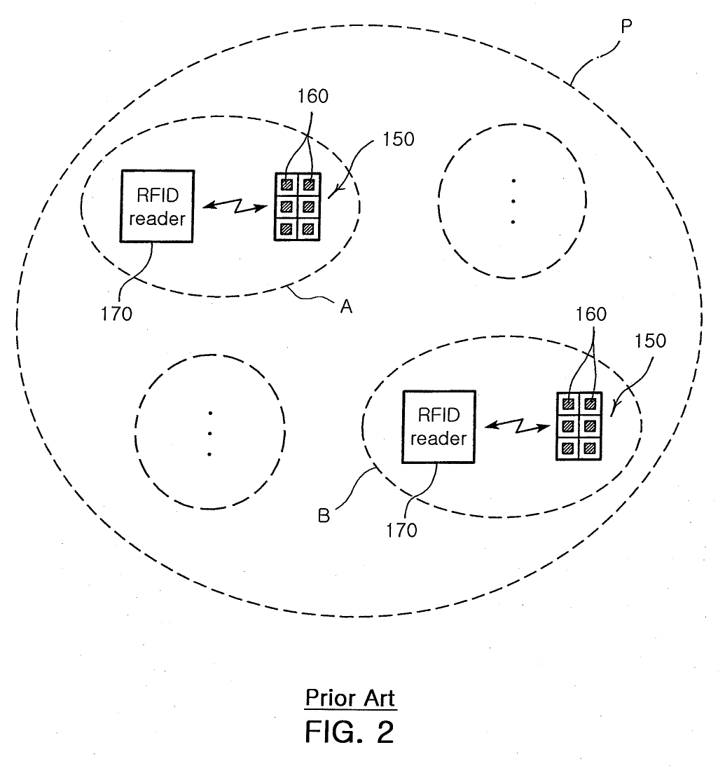

As described above, in the present invention, RFID tags are disposed at target objects which are densely arranged and the RFID tags are read through the wireless communication apparatus, and the location of the wireless communication apparatus that detects the RFID tag is calculated through the fixed anchors, the coordinator and the server. Based on the calculated location of the wireless communication apparatus, the distance to the target object with the RFID tag attached is calculated. Therefore, the location awareness system according to the present invention requires less number of wireless communication apparatuses for communicating with RFID tags compared to the conventional technology described in FIG. 2 by enabling the wireless communication apparatus to communicate with the RFID tag using the RFID reader. Furthermore, after the wireless communication apparatus is directly attached at the huge target object or the cheap RFID tags are disposed at the densely arranged target objects for location awareness, the location awareness system according to the present invention detects the location of the target object through the communication between the RFID tag and the wireless communication apparatus. Therefore, the related cost can be significantly reduced.

As described above, the location awareness system according to the present invention reads the RFID tag attached at a target object through the wireless communication apparatus for location awareness. Therefore, the number of the required RFID reader is significantly reduced and the cost for manufacturing or managing the system is also significantly reduced.

Also, the location awareness system according to the present invention can detect the locations of densely arranged target objects with less cost.

Furthermore, the location awareness system according to the present invention improves the efficiency of managing the system by directly attaching the wireless communication apparatus at a huge target object and disposing RFID tags at densely arranged small target objects.

It will be apparent to those skilled in the art that various modifications and variations can be made in the present invention. Thus, it is intended that the present invention covers the modifications and variations of this invention provided they come within the scope of the appended claims and their equivalents.

1. A location awareness system using RFID (radio frequency identification) comprising:
a RFID tag disposed at a target object for location awareness;
a wireless communication apparatus for location awareness for identifying the target object through communicating with the adjacent RFID tag;
more than three fixed anchors for receiving information about the identified target object and measuring a distance to the wireless communication apparatus by communication with the wireless communication apparatus using a predetermined wireless communication scheme;
a coordinator for collecting the measure distance and the information about the target objects from each of the anchors; and
a server for calculating a location of the target object by receiving information about the measured distances and the target objects from the coordinator and calculating the location of the wireless communication apparatus using the received information.

2. The location awareness system using RFID of claim 1, wherein the wireless communication apparatus is disposed at a target object in which the RFID tag is not disposed.

3. The location awareness system using RFID of claim 1, wherein the wireless communication apparatus includes:
a RFID reader for identifying the target object through communicating with the RFID tag;
a memory for storing information about the identified target object from the RFID reader;
a wireless transceiving unit for transmitting the information about the target object stored in the memory to the anchors and transmitting a response signal for the received distance signal to the anchor using a predetermined wireless communication scheme; and
a micro controller for controlling operations of the RFID reader, the wireless transceiving unit and the memory.

4. The location awareness system using RFID of claim 1, wherein the predetermined wireless communication scheme is one of wireless LAN, Bluetooth, and Zigbee.

5. The location awareness system using RFID of claim 3, wherein the wireless communication apparatus further includes a terminal interface for connecting to other type of a reader instead of the RFID type reader.

6. The location awareness system using RFID of claim 5, wherein the other type reader is a bar code reader.

7. A wireless communication apparatus for location awareness, which communicates with a RFID tag attached at a target object and communicates with anchors to calculate a distance in a location awareness system, the wireless communication apparatus comprising:
a RFID reader for identifying the target object through communicating with the RFID tag;
a memory for storing information about the target object identified at the RFID reader;
a wireless transceiving unit for transmitting the information about the target object stored in the memory to the anchors and transmitting a response signal for a distance calculating signal to anchors using a predetermined wireless communication scheme; and
a micro controller for controlling operations of the RFID reader, the wireless transceiving unit and the memory.

8. The wireless communication apparatus of claim 7, wherein the predetermined communication scheme is a communication scheme for a wireless personal private network (PAN).

9. The wireless communication apparatus of claim 8, wherein the predetermined communication scheme is one of wireless LAN, Bluetooth, and Zigbee.

10. The wireless communication apparatus of claim 7, further comprising a terminal interface for connecting to other type of reader instead of the RFID type reader.

11. The wireless communication apparatus of claim 7, wherein the other type of reader is a barcode reader.
